(19) United States
(12) Patent Application Publication
(10) Pub. No.: US 2014/0344665 A1
(43) Pub. Date: Nov. 20, 2014

(54) IncluSite: web accessibility as a service

(71) Applicant: Company for Software and Development, Valencia (ES)

(72) Inventors: Lorenzo Fernández Albaladejo, Valencia (ES); Ignacio Guarinos Navarro, Valencia (ES); Sergio Lorente Albertos, Valencia (ES); Luis Munoz Lopez, Valencia (ES); Francisco Javer Navarro Lopez, Valencia (ES); Salvador Romero Escandell, Valencia (ES)

(73) Assignee: COMPANY FOR SOFTWARE AND DEVELOPMENT, Valencia (ES)

(21) Appl. No.: 13/897,462

(22) Filed: May 20, 2013

(51) Int. Cl. G06F 17/22

(52) U.S. Cl. CPC G06F 17/2247
USPC 715/234

(57) ABSTRACT

IncluSite is a novel approach to providing web content accessibility as a service. IncluSite automatically inserts code into web pages requested by Internet users to adapt it to web accessibility standards and to add advanced user interfaces right into the web content being served to Internet users. IncluSite allows users with physical or psychical disabilities to navigate web sites in the most suitable way according to their needs, and without the need of specific hardware or software. IncluSite's technical approach also allows web site owners to automatically adapt web contents without changing the original web pages: including a link to IncluSite is sufficient.

### CROSS-REFERENCE TO RELATED APPLICATIONS

Previous provisional patent filed Jan. 24, 2013, under application No. 61/755,996.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

IncluSite is a Software as a Service¹ (SaaS) solution to provide web accessibility to Internet users who suffer from physical or psychical disabilities. This includes people who cannot see, people who cannot use their hands, or people with moderate mental retardation. IncluSite also targets Internet users with low digital competences², like the elderly. ¹ Software as a Service, http://en.wikipedia.org/wiki/Software_as_a_service² Digital Competences, http://ec.europa.eu/digital-agenda/en/pillar-vi-enhancing-digital-literacy-skills-and-inclusion/action-62-eu-wide-indicators-digital

Hence, IncluSite provides a solution to the needs described in U.S. patent classification “A: Human Necessities”.

The current state of technology in the field of web accessibility involves the need to install specific software and hardware in the user's computer. The problems with this approach are:
The user needs to acquire the specific software and hardware, adding extra cost and difficulty to the process of using a computer, which is fundamental to work in many sectors, especially for disabled people.
The user can't use a computer other than his own adapted computer, limiting the mobility of the user.
The software products currently available at the market are too generic, failing to deliver a good user experience, even limiting the functionality of the applications and web pages.

The World Wide Web Consortium³ (W3C) is developing standards on web accessibility, like WAI-ARIA⁴, in order to embed web accessibility in web pages, so that web browsers can provide user interfaces according to the user's skills. The problem is that, in order to make this standard effective, it would take the whole internet to be rewritten in terms of the standards, let alone web browser development companies adjust their browsers to meet the standards. Even then, the user interface provided by modern web browsers do not meet the needs of people that suffer from a range of disabilities that make it impossible to interact with a web page. ³ W3C, http://www.w3.org⁴ WAI-ARIA, http://www.w3.org/WAI/intro/aria.php

### BRIEF SUMMARY OF THE INVENTION

The main idea of IncluSite is to stand in the middle of the web's server-client⁵ scheme to automatically insert additional code into web pages upon a user requesting a web page. The code inserted has two main purposes: it adapts the page to conform to web accessibility standards and it adds advanced user interfaces right into the served web content. ⁵ Server-client architecture, http://en.wikipedia.org/wiki/Client%E2%80%93server_architecture

The first main advantage of this approach is that web site owners do not need to make changes to web pages to make web content accessible. It only takes a link pointing to IncluSite in the original web page to redirect traffic through IncluSite's services to make the whole web site accessible.

The second key advantage is that users get accessible content without additional software or hardware, thus solving the main problems identified in the Background of the Invention section.

Regarding the standards mentioned in previous sections, the adapted web content adheres to web-related specifications like HTML5⁶, WAI-ARIA and WCAG⁷. This allows IncluSite to leverage all progress made by these standards, as well as related features incorporated into web browsers. ⁶ HTML5, http://www.w3.org/html/wg/⁷ WCAG, http://www.w3.org/WAI/intro/wcag.php

### BRIEF DESCRIPTION OF THE SEVERAL VIEWS OF THE DRAWING

FIG. 1: Overall view of an Internet user accessing a web site directly and then through IncluSite.

FIG. 2: Step-by-step description of the internal page adaptation process of IncluSite.

FIG. 3: IncluSite's advanced user interface overlayed in a web page.

### DETAILED DESCRIPTION OF THE INVENTION

This section gives a detailed description of the invention. It first gives an overall view of how IncluSite stands between the Internet user and the targeted Web Site. It then describes in detail how the invention adapts web pages to conform to accessibility standards and how it embeds an advanced user interface to aid the user to navigate the web contents. Then it goes on to describe in more detail how this advanced user interface works.

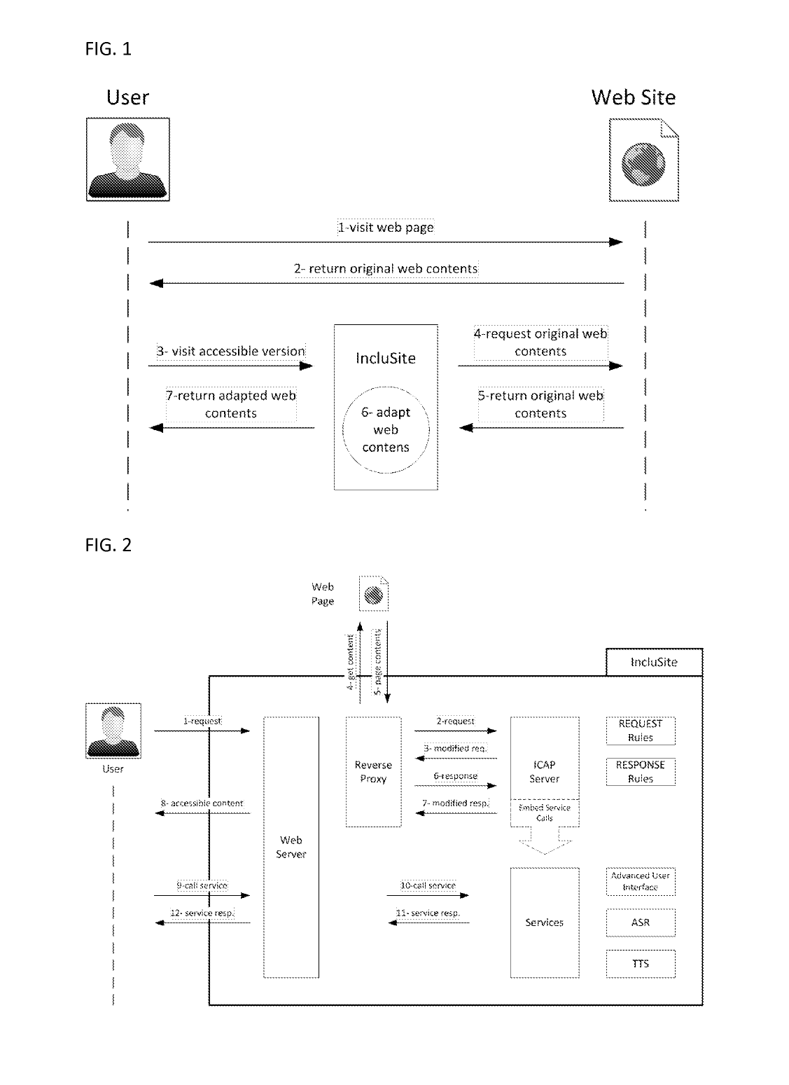

FIG. 1 shows the interactions between an Internet user, the Web site it intends to visit, and IncluSite.

The following paragraphs give a detailed, step-by-step explanation of the sequence of labeled events shown in FIG. 1:

Step 1: To begin with, a user enters a web page URL⁸ in a web browser to visit a web site (label “1—visit web page”). The server hosting the original web site returns the requested web page (label “2—return original web contents”). ⁸ URL, http://www.ietf.org/rfc/rfc1738.txt

Step 2: Now let this web site be subscribed to the services of IncluSite. Therefore, there is a link to the accessible version of the web page. This link points to IncluSite's web server depicted in FIG. 1 (labeled “3—visit accessible version”). Visiting this link will initiate the operation of the invention.

Step 3: IncluSite will make a request to the original web site on behalf of the Internet user (label “4—request original web contents”).

Step 4: The contents returned by the original web site (label “5—return original web contents”) is then adapted by IncluSite (label “6—adapt web contents”) to make these web contents conform to web accessibility standards and add the advanced user interface to meet the Internet user's needs and preferences.

Step 5: Return the adapted web content to the user (label “7—return adapted web contents”).

Having depicted how IncluSite stands between the user and the targeted web site, the following paragraphs describe in more detail how the invention works to adapt web contents to the needs and preferences of Internet users, without enforcing the web site owner to make changes to its web pages.

The explanation of how IncluSite works begins with describing the elements comprising the invention and then describing how they interact to achieve the expected result.

The invention consists of the group of software components drawn as boxes in FIG. 2. The following is a brief description of each of these components:

1. Web Server⁹: A software that accepts web page requests from the user and returns such contents. An example of such software is Apache HTTP Server¹⁰. This is IncluSite's main point of access. ⁹ Web Server, http://en.wikipedia.org/wiki/Web_server¹⁰ Apache HTTP Server, http://httpd.apache.org/

2. Reverse Proxyl¹¹: A software that retrieves resources on behalf of the user. An example of such software is Squid¹². ¹¹ Reverse Proxy, http://en.wikipedia.org/wiki/Reverse_proxy¹² Squid Proxy, http://www.squid-cache.org/

3. ICAP Server: A software that performs modifications on HTTP requests and responses. This component performs web content adaptation applying programmatic rules specific for HTTP requests and HTTP responses.

4. Services: A custom component that provides services like Advanced User Interface,

Automatic Speech Recognition¹³ (ASR) and Text to Speech¹⁴ (US). A reference to these services is embedded in the adapted web page. These services are called from the user's web browser using web methods like AJAX¹⁵. ¹³ Automatic Speech Recognition, http://en.wikipedia.org/wiki/Automatic_speech_recognition¹⁴ Text to Speech, http://en.wikipedia.org/wiki/Text_to_speech¹⁵ AJAX, http://en.wikipedia.org/wiki/Ajax_%28programming%29

Now that the main components of the invention have been introduced, the best way to explain how IncluSite works is by describing the process that is triggered upon a user requesting a web page, following it through until the accessible content is served to the user. The picture in FIG. 1 shows the complete process.

The following paragraphs give a detailed, step-by-step explanation of the sequence of labeled events shown in FIG. 2:

Step 1. A user requests the accessible version of a web page thanks to a link included in the original web page (label “1—request”). The link points to a web server which is inside the domain of the invention.

Step 2. Upon user request, the web server passes on this request to a reverse proxy. The reverse proxy issues a request modification of the user's HTTP¹⁶ request to an ICAP¹⁷ server (label “2—request”). ¹⁶ Hypertext Transfer Protocol, http://en.wikipedia.org/wiki/HTTP¹⁷ Internet Content Adaptation Protocol, http://tools.ietf.org/html/rfc3507

Step 3. The ICAP server grabs the original request to rewrite HTTP headers (like the Host¹⁸ header) and links inside the HTML to point them to the original web page address. The modified request is returned to the reverseproxy (label “3—modified req.”). ¹⁸ HTTP Host header, http://tools.ietf.org/html/rfc2616#section-14.23

Step 4. The reverse proxy requests the contents to the original web page on behalf of the user (label “4—get content”) and gets the contents (“5—page contents”).

Step 5. The reverse proxy sends the original contents to the ICAP server (label “6—response”). The ICAP server performs two fundamental actions upon these contents: (1) it rewrites HTTP headers and HTML links to point to IncluSite, and (2) it adds the code of IncluSite's advanced user interface. Then it returns this adapted web content to the reverse proxy (label “7—modified resp.”).

Step 7. The reverse proxy sends to the user the original web content plus the code to make it accessible (label “8—accessible content”). This code contains IncluSite's advanced user interface. This piece of code is programmed in browser-friendly languages, like JavaScript, and is embedded directly into the web response. This code will later make calls to server-side services like Text-to-Speech¹⁹ (TTS) and Automatic Speech Recognition²⁰ (ASR), as described in the next step. ¹⁹ Text to Speech, http://en.wikipedia.org/wiki/Text_to_speech²⁰ Automatic Speech Recognition, http://en.wikipedia.org/wiki/Automatic_speech_recognition

Step 8. Once the web contents are loaded in the user's web browser, IncluSite's advanced user interface starts to execute to help the user interact with the adapted web content according to the user's communication abilities. To achieve this, IncluSite's advanced user interface makes calls to services like ASR and TTS (label “9—call service”). This service call goes through the web server to the services layer (label “10—call service”), returning an appropriate response (label “11—service resp.”). When the response is received at the user's web browser (label “12—service resp.”), IncluSite's advanced user interface will make use of it to communicate with the user in a way most suitable to the user's circumstances or preferences.

Having described how the invention works to adapt web content to make it accessible, the following paragraphs describe how IncluSite's advanced user interface helps users to navigate the web page according to the user's communication abilities or preferences.

IncluSite's advanced user interface consists of common navigation elements that interact with the user in different ways. Each way depends on the user's communication skills or preference. For instance, IncluSite's advanced user interface will read aloud the web page contents and will allow accept voice commands from blind users.

IncluSite's advanced user interface leverages standard peripherals found in computers, like the mouse, the keyboard, the microphone and the speakers, to let the user interact with the web page in the most suitable way according to the user's needs and preferences.

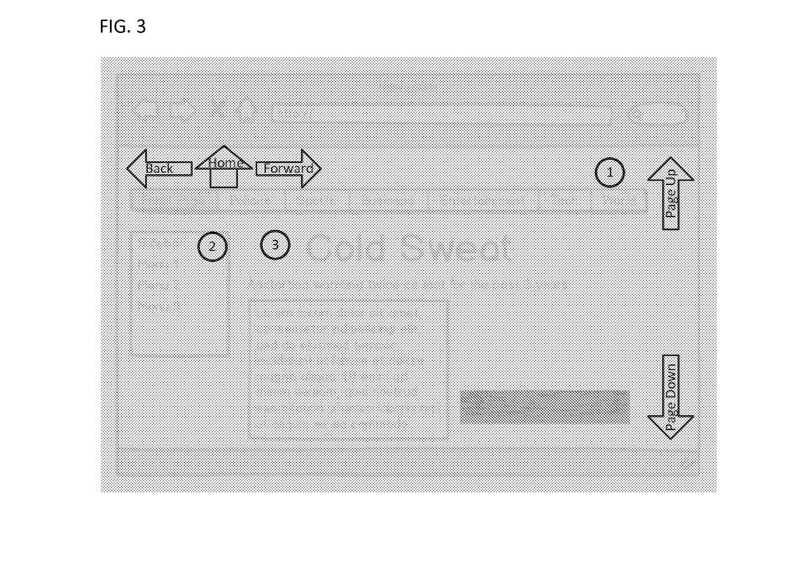

FIG. 3 shows a schematic example of the IncluSite's advanced user interface overlayed in a web page. It shows some basic controls to navigate the web page: Back and Forward, Home, Up and Down, and some numbered boxes to access directly to specific sections of the web page.

These controls are always present, and stand out from the content to make it clear that they don't belong to the content. These are just for navigation purposes.

The user interacts with these controls in different ways, depending on its communication skills or preferences. IncluSite's advanced user interface has a one-time setup step to configure the user's preferred mode of interaction. These preferences are stored across all web sites.

The following is a list of scenarios of user interaction:

1. The user uses the keyboard's arrow keys to go up or down the page, or hit a number to go directly to a section number.

2. The user speaks voice commands like “up” or “home” to activate the navigation controls by means of the aforementioned ASR service.

3. In the case the user can't speak, the user can make a sound to select the navigation options. Options activate sequentially until a sound is detected, and then the option is selected.

4. In the case of severe paralysis, the user can make gestures to the webcam with his head, mouth, eyes, or any other visible portion of his/her face to use the navigation controls. One example of this is the eye-tracking technique, by means of which the user's eyes positions are detected by the camera to highlight the different options, and select an option when long eye-blinking is detected.

5. A user can simply use the mouse to click on these navigation controls.

In response to the user's input, IncluSite's advanced user interface gives feedback to in the most appropriate way to the user's communication skills. For instance, for blind people, it reads aloud the available navigation options and the selected web content, by means of the aforementioned TTS service. It can also magnify the selected section to make it visible for people with dimmed sight.

1. A software architecture that enables web sites to adapt its web pages to the needs of Internet users with physical disabilities, psychical disabilities, or low digital competences, like people who cannot use their hands, people with moderate mental retardation, or the elderly, by means of subscribing to a web accessibility service, without the need to modify the source code of the original web pages, other than adding a link to the accessible version of the web site, such software architecture comprising means for accepting web requests by Internet users and adapting web pages to the needs of the user before returning the adapted content to the user.

2. A software architecture according to claim 1 that enables existing web pages to conform to accessibility standards by subscribing to an external service.

3. A software architecture according to claim 1 that enables existing web pages to conform to accessibility standards without enforcing the web site owner to change its source code, other than adding a link to the accessible version of the web site.

4. A software architecture according to claim 1 to embed advanced user interfaces into the served web page to allow people with physical and psychical disabilities to navigate a web page without the need to acquire extra software or hardware specific to his or her disability.

5. An advanced user interface that allows users to navigate web content adapted by the invention, supporting standard computer peripherals like keyboard, microphone, webcam and mouse and request the system to read aloud the web page, such user interface comprising common web navigation actions to go up or down a page, go to the home of the web site, go back or forward in navigation history, or go to a specific section of the web page.

6. An advanced user interface according to claim 5 wherein the navigation controls are activated by means of the keyboard.

7. An advanced user interface according to claim 5 wherein the navigation controls are activated by means of voice commands spoken to a standard microphone.

8. An advanced user interface according to claim 5 wherein the navigation controls are activated by means of sounds or noises made by mumbling, blowing, or any other means within the abilities of the user, to a standard microphone.

9. An advanced user interface according to claim 5 wherein the navigation controls are activated by means of the user's eye positions tracked by a webcam, also known as eye-tracking.

10. An advanced user interface according to claim 5 wherein the navigation controls are activated by means of the gestures captured by a webcam, like moving the head up, down, sideways or sideways.

11. An advanced user interface according to claim 5 wherein the navigation controls are activated by means of the mouse.

12. An advanced user interface according to claim 5 wherein the page contents are read aloud to the user by means of the speakers incorporated to the user's computer.

13. An advanced user interface according to claim 5 wherein the page contents selected by the user are magnified to make them more visible.
